(19) United States
(12) Patent Application Publication
(10) Pub. No.: US 2025/0365675 A1
(43) Pub. Date: Nov. 27, 2025

(54) POWER-SAVING METHOD AND VEHICLE COMMUNICATION DEVICE THEREOF

(71) Applicant: MediaTek Singapore Pte. Ltd., Singapore (SG)

(72) Inventor: Ziyao XIONG, Shenzhen (CN)

(21) Appl. No.: 18/788,503

(22) Filed: Jul. 30, 2024

(30) Foreign Application Priority Data
May 23, 2024 (CN) 202410649710.0

(51) Int. Cl. H04W 52/02; H04W 40/00

(52) U.S. Cl. CPC H04W 52/0274; H04W 40/005; H04W 52/0229

(57) ABSTRACT

A power-saving method is provided. The power-saving method may be applied in a vehicle communication device in a vehicle. The power-saving method may include the following steps. A processor of the vehicle communication device may determine whether the vehicle is turned off. In response to the vehicle being turned off and not being charged, the processor may determine the current communication environment of the vehicle. Then, the processor may reserve the transmission of the specific data on at least one communication path between the processor and a modem of the vehicle communication device according to the current communication environment, wherein the communication path comprises a control path and a data path. Then, the processor may enter a sleep mode.

### CROSS-REFERENCE TO RELATED APPLICATIONS

This Application claims priority of China Patent Application No. 202410649710.0, filed on May 23, 2024, the entirety of which is incorporated by reference herein.

### BACKGROUND

### Field of the Invention

The invention generally relates to power-saving technology, and more particularly, to power-saving technology for use in a telematics box (TBox) of a vehicle.

### Description of the Related Art

As demand for ubiquitous computing and networking has grown, various wireless technologies have been developed, including Wireless-Fidelity (Wi-Fi) which is a Wireless Local Area Network (WLAN) technology allowing vehicles, mobile devices (such as a smartphones, smart pads, laptop computers, portable multimedia players, embedded apparatuses, and the like) to obtain wireless services.

In conventional technology, a telematics box (TBox) may be configured in a vehicle to provide network service. In addition, when the vehicle is turned off, a dedicated battery in the vehicle may be used to provide power to the TBox. Therefore, when the vehicle is turned off, the modem (MD) of the TBox can be used to receive remote commands or wake-up sources to turn on the vehicle or perform other operations. The modem (MD) of the TBox can wake up the application processor (AP) of the TBox through these wake-up sources. However, when MD frequently wakes up the AP using the wake-up sources, power consumption from the dedicated battery will be increased. When the dedicated battery is fully depleted, the vehicle will not be able to be turned on.

Therefore, how to decrease the wake-up sources to reduce the power consumption of the dedicated battery for the TBox is a topic that is worthy of discussion.

### BRIEF SUMMARY OF THE INVENTION

Power saving methods and vehicle communication device are provided to overcome the problems mentioned above.

An embodiment of the invention provides a power-saving method. The power-saving method may be applied in a vehicle communication device in a vehicle. The power-saving method may comprise the following steps. A processor of the vehicle communication device may determine whether the vehicle is turned off. In response to the vehicle being turned off and not being charged, the processor may determine the current communication environment of the vehicle. Then, the processor may reserve the transmission of the specific data on at least one communication path between the processor and a modem of the vehicle communication device according to the current communication environment, wherein the communication path comprises a control path and a data path. Then, the processor may enter a sleep mode.

In some embodiments, the processor may disable the transmission of all wake-up sources in response to the vehicle being turned off and being charged. The wake-up sources are configured to wake up the processor which is in the sleep mode.

In some embodiments, in response to the current communication environment being a 2G or 3G network, the processor may reserve the Short Message Service (SMS) and the emergency call service on the control path. In addition, the processor may deactivate the transmission of all packet data network (PDN) on the control path and the data path.

In some embodiments, in response to the current communication environment being a 4G or 5G network, the processor may reserve the Short Message Service (SMS), the emergency call service and the unsolicited network interface control indication on the control path, reserve the transmission of an Internet Protocol (IP) multimedia subsystem (IMS) PDN on the control path, and deactivate the transmission of other PDNs on the control path. In some embodiments, the processor may only reserve the transmission of control protocol/IP (TCP/IP) packets associated with Internet Control Message Protocol version 6 (ICMPv6) on the data path according to a setting. The TCP/IP packets may comprise router solicitation router advertisement (RSRA) packet. In some embodiments, the processor may avoiding camping on a 5G cell with a weak 5G signal based on a threshold.

In some embodiment, the processor may obtain state information of the vehicle through a control area network (CAN) bus from a vehicle host device of the vehicle.

An embodiment of the invention provides a vehicle communication device. The vehicle communication device may include a modem and a processor. The processor is coupled to the modem. The processor is configured to determine whether the vehicle is turned off, determine the current communication environment of the vehicle in response to the vehicle being turned off and not being charged, reserve the transmission of the specific data on at least one communication path between the processor and a modem of the vehicle communication device according to the current communication environment, wherein the communication path comprises a control path and a data path. Then, the processor may enter a sleep mode.

Other aspects and features of the invention will become apparent to those with ordinary skill in the art upon review of the following descriptions of specific embodiments of the power-saving methods and vehicle communication device.

### BRIEF DESCRIPTION OF THE DRAWINGS

The invention will become more fully understood by referring to the following detailed description with reference to the accompanying drawings, wherein:

FIG. 1 is a block diagram of a vehicle communication system 100 according to an embodiment of the application.

FIG. 2 is a block diagram illustrating a vehicle communication device according to an embodiment of the application.

FIG. 3 is a block diagram illustrating a network node according to an embodiment of the application.

FIG. 4 is a schematic diagram illustrating transmission of a control path and a data path according to an embodiment of the application.

FIG. 5 is a flow chart illustrating a power-saving method according to an embodiment of the invention.

### DETAILED DESCRIPTION OF THE DISCLOSURE

The following description is of the best-contemplated mode of carrying out the invention. This description is made for the purpose of illustrating the general principles of the invention and should not be taken in a limiting sense. The scope of the invention is best determined by reference to the appended claims.

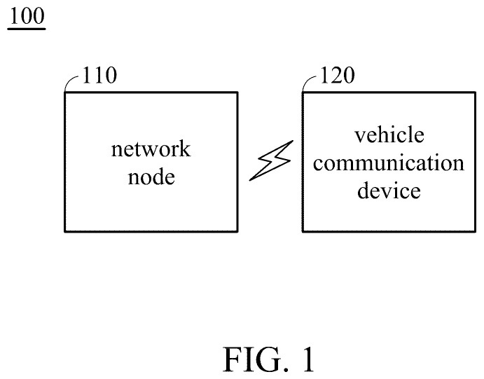

FIG. 1 is a block diagram of a vehicle communication system 100 according to an embodiment of the application. As shown in FIG. 1, the vehicle communication system 100 may include a network node 110 and a vehicle communication device 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point, an access terminal, but the invention should not be limited thereto. In the embodiment, the vehicle communication device 120 may communicate with the network node 110 through the second generation (2G) communication technology, the third generation (3G) communication technology, the fourth generation (4G) communication technology, fifth generation (5G) communication technology (or 5G New Radio (NR) communication technology), or sixth generation (6G) communication technology, but the invention should not be limited thereto.

In the embodiments of the invention, the vehicle communication device 120 may be a telematics box (TBox). The vehicle communication device 120 may be configured in a vehicle (e.g., a car). The vehicle communication device 120 may be coupled to a vehicle host device of the vehicle. The vehicle communication device 120 may provide the network service to the vehicle. The vehicle communication device 120 may also be configured to start the engine of the vehicle. In addition, when the vehicle is turned off, a dedicated battery in the vehicle may be used to provide power to the vehicle communication device 120.

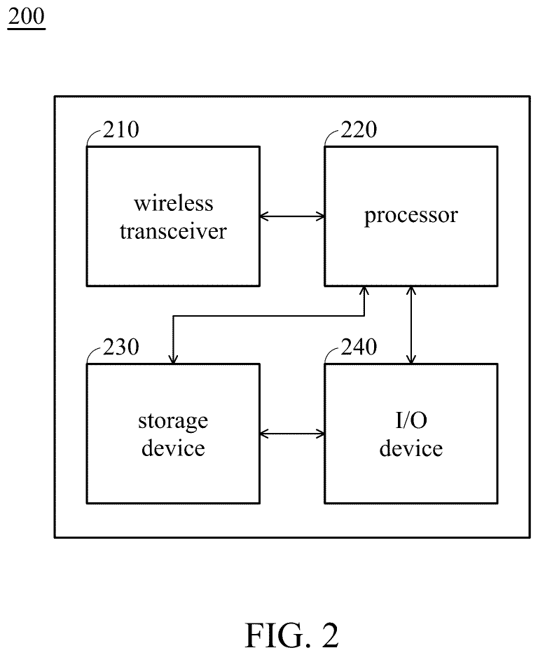

FIG. 2 is a block diagram illustrating a vehicle communication device 200 according to an embodiment of the application. The vehicle communication device 200 can be applied to the vehicle communication device 120. As shown in FIG. 2, the vehicle communication device 200 may comprise a wireless transceiver 210, a processor 220, a storage device 230, and an Input/Output (I/O) device 240.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for uplink (UL)/down link (DL) MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, and receiving user inputs or outputting signals via the I/O device 240.

In particular, the processor 220 coordinates the aforementioned operations of the wireless transceiver 210, the storage device 230, and the I/O device 240 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The I/O device 240 may include one or more connection interfaces or ports. For example, the vehicle communication device 200 may be connected to the vehicle host device of the vehicle through a control area network (CAN) bus of the I/O device 240.

According to an embodiment of the invention, the wireless transceiver 210 may be configured in a modem (MD) of the communication apparatus 200, and the processor 220 may be configured in an application processor (AP) of the communication apparatus 200. When the vehicle us turned off, the AP may enter a sleep mode to save power of the dedicated battery which configured for the communication apparatus 200 in the vehicle. In the embodiments of the invention, the MD may wake up the AP from the sleep mode only when the MD needs to receive or transmit the specific data (e.g., Short Message Service (SMS) and emergency call (eCall) service, but the invention should not be limited thereto) from or to the network node. That is, in the embodiments of the invention, only the transmission of the specific data on the communication path between the AP and MD will be reserved (or allowed), and the transmission of other wake-up resources will be deactivated or disabled. Details will be discussed below.

It should be understood that the components described in the embodiment of FIG. 2 are for illustrative purposes only and are not intended to limit the scope of the application.

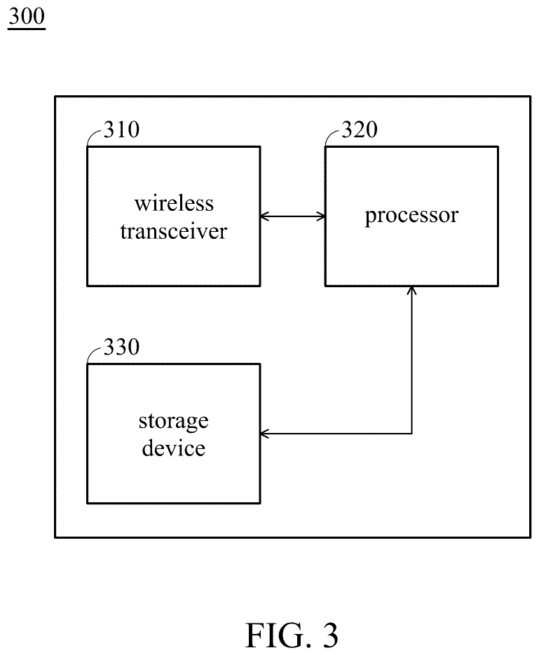

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPU/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application.

According to an embodiment of the invention, the processor (or application processor) of the vehicle communication device 120 may determine whether the vehicle is turned off. In an embodiment, the vehicle communication device 120 may obtain the state information of the vehicle through a CAN bus from the vehicle host device of the vehicle. The state information may indicate that the vehicle is turned off or not. In addition, the state information may indicate that the vehicle is being charged or not.

When the vehicle is turned off, but the vehicle is charged, in order to the safety concerns, the processor of the vehicle communication device 120 may disable the transmission of all wake-up sources which are configured to wake up the processor when the processor is in the sleep mode. That is, when the vehicle is charged, the modem of the vehicle communication device 120 cannot wake up the processor which is in the sleep mode through any wake-up source.

When the vehicle is turned off and is not charged, the processor of the vehicle communication device 120 may determine the current communication environment of the vehicle. The processor of the vehicle communication device 120 may determine the current communication environment of the vehicle based on the camping state of the modem of the vehicle communication device 120. For example, the modem of the vehicle communication device 120 may camp on 2G cell or 3G cell (i.e., the current communication environment of the vehicle communication device 120 supports 2G or 3G communication), or the modem of the vehicle communication device 120 may camp on 4G cell or 5G cell (i.e., the current communication environment of the vehicle communication device 120 supports 4G or 5G communication). Then, the processor of the vehicle communication device 120 may reserve the transmission of the specific data on the communication path between the processor and the modem of the vehicle communication device 120 according to the current communication environment. That is, except for the transmission of the specific data, the transmission of other wake-up resources will be deactivated or disabled. The communication path may comprise a control path and a data path.

According to an embodiment of the invention, when the current communication environment is 2G or 3G network (i.e., circuit switching (CS) transmission is supported), the processor of the vehicle communication device 120 may reserve the Short Message Service (SMS) and emergency call (eCall) service on the control path. In addition, in the embodiment, the processor of the vehicle communication device 120 may deactivate the transmission of all packet data network (PDN) on the control path and the data path between the processor and the modem of the vehicle communication device 120. That is, in the embodiment, the modem can wake up the processor entered the sleep mode only through the SMS or eCall on the control path between the processor and the modem.

According to another embodiment of the invention, when the current communication environment is 4G or 5G network (i.e., packet switching (PS) transmission is supported), the processor of the vehicle communication device 120 may reserve the SMS, eCall service, and unsolicited network interface control indication on the control path. In addition, the processor may reserve the transmission of an Internet Protocol (IP) multimedia subsystem (IMS) PDN on the control path, and deactivate the transmission of other PDNs on the control path. That is, in the embodiment, the modem can wake up the processor entered the sleep mode only through the SMS, eCall, or unsolicited network interface control indication, or IMS PDN on the control path between the processor and the modem. In addition, in the embodiment, the processor may only reserve the Transmission of Control Protocol/IP (TCP/IP) packets associated with Internet Control Message Protocol version 6 (ICMPv6) on the data path according to a packet filter setting (e.g., the setting of SET_PACKET_FILTER). In an example, the TCP/IP packets may comprise router solicitation router advertisement (RSRA) packets. The setting of SET_PACKET_FILTER can be used to filter other packets to reserve the RSRA packets

In addition, in an embodiment of the invention, when the current communication environment is 4G network, the processor of the vehicle communication device 120 may avoid camping on a 5G cell with a weak 5G signal based on a threshold. Specifically, the processor may increase the threshold to avoid camping on a 5G cell with a weak 5G signal. Therefore, the vehicle communication device 120 may keep camping on the 4G cell to avoid switching between 4G cell and 5G cell frequently. That is, the ping-pong effect can be avoided.

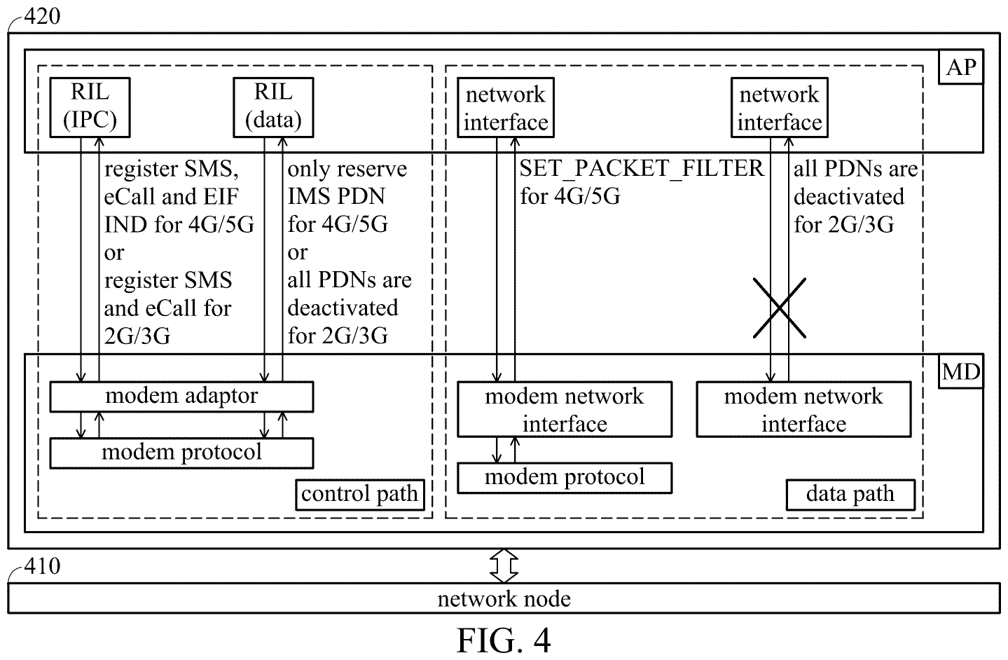

FIG. 4 is a schematic diagram illustrating transmission of a control path and a data path according to an embodiment of the application. The network node 410 and the vehicle communication device 420 may be applied to the network node 110 and the vehicle communication device 120 of FIG. 1. The vehicle communication device 420 may comprise a modem (MD) and an application processor (AP). As shown in FIG. 4, when the current communication environment is 4G or 5G network, in the control path, the SMS, eCall and unsolicited network interface control indication may be registered (or reserved) for the inter-process communication (IPC) in the radio interface layer (RIL) between the MD and AP, and the IMS PDN may be reserved for the data transmission in the RIL. In addition, when the current communication environment is 4G or 5G network, in the data path, the setting of SET_PACKET_FILTER will be used to filter other packets to reserve the transmission of the TCP/IP packets associated with ICMPv6 (e.g., RSRA packets) between the network interface of AP and the modem network interface.

Furthermore, shown in FIG. 4, when the current communication environment is 2G or 3G network, in the control path, the SMS and eCall may be registered (or reserved) for the IPC in the RIL between the MD and AP, and all PDNs for the data transmission in the RIL may be deactivated. In addition, when the current communication environment is 2G or 3G network, in the data path, all PDNs for the data transmission between the network interface of AP and the modem network interface may be deactivated.

The control path may include an RIL module, a modem adapter module and a modem protocol module. The RIL module may further include the RIL IPC module and the RIL data module. The data path may include an AP-side network interface module, an MD-side network interface module and a modem protocol module.

As shown in FIG. 4, when the current communication environment is a 4G or 5G network, SMS, eCall and unsolicited network interface control indications may be retained on the control path, and data transmission of IMS PDN may be retained on the control path, and other PDN data may be deactivated transmission. Only the transmission of Control Protocol/IP (TCP/IP) data packets related to Internet Control Message Protocol version 6 (ICMPv6) according to the packet filtering settings (for example: SET_PACKET-FILTER) may be retained on the data path, thereby achieving the purpose of saving power while responding to key events and service needs when the vehicle is turned off.

The following describes the specific operations of the control path and data path when the current communication environment is a 4G or 5G network. First, the RIL module may convert requests from high-level applications (such as SMS sending, eCall initiation) into MD control instructions. After MD receives the control instructions, it may return a response. Then, the RIL module may convert the MD response into a format that can be processed by the AP. The RIL module may be divided into an RIL IPC module and an RIL data module, which enables the AP to process control signals and data related to network communication more effectively. This subdivision helps to respond to key events when the vehicle is turned off. The purpose of saving power is achieved under the premise of meeting the needs of power saving and service requirements. The RIL IPC module may be responsible for handling inter-process communication and transmitting control instructions between AP and MD. The RIL IPC module may send control instructions to high-level applications (such as phone applications, SMS services, etc.) and receives responses from the MD. In some complex communication processes, such as emergency calls (eCall), the RIL IPC module may be responsible for maintaining session status and ensuring communication continuity and consistency. The RIL IPC module may be also responsible for monitoring errors during the communication process and reporting the MD status and error messages to the upper-layer application. The RIL data module may be responsible for initializing and establishing data connections. When the current communication environment is a 4G or 5G network, the data transmission of IMS PDN may be retained on the control path and other PDN data transmission may be deactivated. Once the IMS PDN connection is established, the RIL data module may manage the life cycle of this connection, including maintenance, monitoring and reconnecting when needed, manage IMS PDN connections to provide IMS PDN services while being able to disconnect other IMS PDN connections and reconnect IMS PDN in a timely manner to save power.

When the current communication environment is a 4G or 5G network, the modem adapter module included in MD may process the control instructions sent from the AP through the RIL module. These instructions may include network connection settings (such as making IMS PDN connections, disconnecting other PDN connections), calling Control, SMS sending request, eCall activation signal, etc. The modem adapter module may parse these instructions and performs corresponding operations, such as connecting to the network (such as making an IMS PDN connection), sending SMS, or handling emergency calls. After the operation is completed, the modem adapter module may generate a response, such as a confirmation signal indicating that the command was successfully executed, or a complex response, such as the status of the network connection, an error code, or returned data. The response may be sent back to the RIL IPC module included on the AP side. Then, the RIM IPC module may convert the response into a format suitable for the AP and pass it to the responding application or service through the IPC mechanism. Once the response reaches the AP, the responding application or service will process this response, complete the operation of waking up the AP, and then perform the corresponding operation according to the user's wake-up operation instructions. For example, remotely turn on the air conditioner, remotely turn on the ventilation in the car, etc.

When the current communication environment is a 4G or 5G network, in the above process, the modem protocol on the control path actually establishes or disconnects from the mobile network according to the instructions parsed by the modem adapter, and is responsible for implementing and managing modem communication protocols compliant with standards such as 3GPP. The modem protocol on the control path may confirm that all control signals and data transmission follow the correct communication protocol to ensure compatibility with the network and reliability of communication. In the embodiment of the present disclosure, the modem protocol module executes the instructions of the modem adapter module on establishing an IMS PDN connection, and actually establishes a connection with the mobile network. Specifically, for data transmission of IMS PDN (such as VoLTE or video pass), the modem protocol module processes data packets related to the IP multimedia subsystem and confirms that they can be sent and received correctly through network connections. On the other hand, on the control path, the modem protocol module may execute the instructions of the modem adapter module to deactivate other PDN connections and identify the IMS PDN connections that need to be retained. However, for non-IMS PDN connections, the Modem protocol actually disconnects from its mobile network.

The above control instructions and response mechanisms between AP and MD can be effectively transmitted, so that the device can correctly interact with the mobile network when the device is turned off and provide users with the required services. The response mechanism may be also an important part of error handling and status monitoring, allowing the AP to detect and handle any problems that may occur in an emergency state, so as to achieve power saving while responding to key events and service needs when the vehicle is turned off.

When the current communication environment is a 4G or 5G network, the unsolicited network interface control indications may refer to notifications or instructions that are not explicitly requested by the AP but are actively sent to the AP by the MD. When the vehicle is turned off, the unsolicited network interface control indications such as emergency calls (theft alarm indication, remote control indication, vehicle status update, maintenance and diagnostic information, software update notification, low battery warning, environmental detection indication, vehicle tracking indication, emergency service notifications, etc.). On the MD side, if a change in time or state triggers an unsolicited command event, the modem adapter module may generate a corresponding unsolicited network interface control command based on the event. The generated unsolicited network interface control instructions may be sent to the AP through the RIL IPC module. The RIL IPC module may be responsible for converting these unsolicited network interface control instructions into a format suitable for the AP and passing them to the corresponding service or application through the IPC mechanism. The corresponding service or application may perform the corresponding operation according to the received unsolicited network interface control instruction. The control path will ensure that emergency information can be processed in a timely manner while minimizing the consumption of the vehicle battery, so that when the vehicle is turned off, it can achieve the purpose of saving power while responding to critical events and service needs.

In the embodiment of the present invention, if the unsolicited network interface control instruction is an emergency service notification, when the vehicle is turned off, the modem protocol module in the control path may maintain a low-power listening mode so as to be able to receive emergency service notifications from the mobile network. In a certain event or state, if the emergency service notification event is triggered, the modem protocol module may receive the emergency service notification and pass it to the modem adapter module. The modem adapter module may parse and convert the emergency service notification and pass it through RIL module (RIL IPC module) to the AP, and the AP may perform specific response actions based on the content of the emergency service notification, such as activating the vehicle's warning system or issuing a warning to the user through the vehicle's user interface component, which can include car key remote controls, vehicle external LED indicators or smartphone applications, etc. After the emergency notification processing is completed, the AP may return to the low-power state according to the power management policy.

In addition, when the current communication environment is a 4G or 5G network, in the data path, packet filtering settings may be used to define which types of data packets should be transmitted and which should be filtered. The rules set by packet filtering are based on the characteristics of the packet, such as protocol type, source address, destination address, port number, etc. In the data path, the network interface on the AP side and the network interface on the MD side may both follow the packet filtering settings to ensure that only data packets that comply with the packet filtering settings are transmitted between the AP and MD. The modem protocol module in the data path may follow the data packet filtering settings to handle received and sent packets. In the embodiment of the present disclosure, SET_PACKET-FILTER may be set to filter other data packets and only retain TCP/IP data packets related to ICMPv6 (for example, RSRA packets) for transmission between the AP's network interface and the modem network interface, in order to achieve the purpose of saving power while ensuring the efficiency and security of the network.

In addition, as shown in FIG. 4, when the current communication environment is a 2G or 3G network, SMS, eCall on the control path is retained, and all PDN data transmission is deactivated on the control path, and all PDN data transmission is deactivated on the data path, thereby achieving the purpose of saving power while responding to key events and service needs when the vehicle is turned off.

The following describes the specific operations of the control path and data path when the current communication environment is a 2G or 3G network. First, the RIL module may convert requests from high-level applications (such as SMS sending, eCall initiation) into MD control instructions. After MD receives the control instructions, it may return a response. Then, the RIL module may convert the MD response into a format that can be processed by the AP. The RIL module is divided into RIL IPC module and RIL data module, which enables the AP to process control signals and data related to network communication more effectively. Such subdivision helps to respond to key events when the vehicle is turned off. The purpose of saving electricity is achieved under the premise of meeting the needs of energy saving and service needs. The RIL IPC module may be responsible for handling inter-process communication and transmitting control instructions between AP and MD. The RIL IPC module may send control instructions to high-level applications (such as phone applications, SMS services, etc.) and receive responses from the MD. In some complex communication processes, such as emergency calls (eCall), the RIL IPC module may be responsible for maintaining session status and ensuring communication continuity and consistency. It is also responsible for monitoring errors during the communication process and reporting the MD status and error messages to the upper-layer application. The RIL's data module may be responsible for initializing and establishing data connections. When the current communication environment is a 2G or 3G network, all PDN data transmission is disabled on the control path to save power.

When the current communication environment is a 2G or 3G network, the modem adapter module included in the MD on the control path may process the control instructions sent from the AP through the RIL module. These instructions may include network connection settings (such as disconnecting PDN connections), call control, SMS sending request, eCall activation signal, etc. The modem adapter module parses these instructions and performs corresponding operations, such as sending SMS or handling emergency calls. After the operation is completed, the Modem adapter module may generate a response, such as a confirmation signal indicating that the command was successfully executed, or a complex response, such as the status of the network connection, an error code, or returned data. The response may be send back to the RIL IPC module included on the AP side. Then, the RIL IPC module may convert the response into a format suitable for the AP and pass it to the responding application or service through the IPC mechanism. Once the response reaches the AP, the responding application or service will process this response, complete the operation of waking up the AP, and then perform the corresponding operation according to the user's wake-up operation instructions, for example, remotely turn on the air conditioner, remotely turn on the ventilation in the car, etc.

When the current communication environment is a 2G or 3G network, during the above process, the modem protocol on the control path may actually disconnect from all PDNs according to the instructions parsed by the modem adapter, and be responsible for implementing and managing modem communication protocols that comply with 3GPP and other standards. The modem protocol on the control path may confirm that all control signals and data transmission follow the correct communication protocol to ensure compatibility with the network and reliability of communication. In the embodiment of the present disclosure, the modem protocol module may execute the instruction of the modem adapter module to disconnect the PDN, and actually disconnect from its mobile network. On the other hand, on the control path, the modem protocol module may execute the modem adapter module's instructions to deactivate all PDN connections, and the modem protocol actually disconnects from its mobile network. On the data path, all PDN connections are disabled, the AP-side network interface module may be shut down, for example, the IP address configuration and routing settings of the network interface are disabled, and the MD-side network interface is shut down, and the MD-side network interface module indicates MD to release the corresponding bearer resources and disconnect the network, the modem protocol module stops sending and receiving all data packets, and sends a PDN disconnect request to the mobile phone through the network protocol, actually disconnecting from its mobile network.

The above control instructions and response mechanisms between AP and MD can be effectively transmitted, so that the device can correctly interact with the mobile network when the device is turned off, and provide users with the required services. The response mechanism is also an important part of error handling and status monitoring, allowing the AP to detect and handle any problems that may occur in an emergency state, to achieve power saving while responding to key events and service needs when the vehicle is turned off.

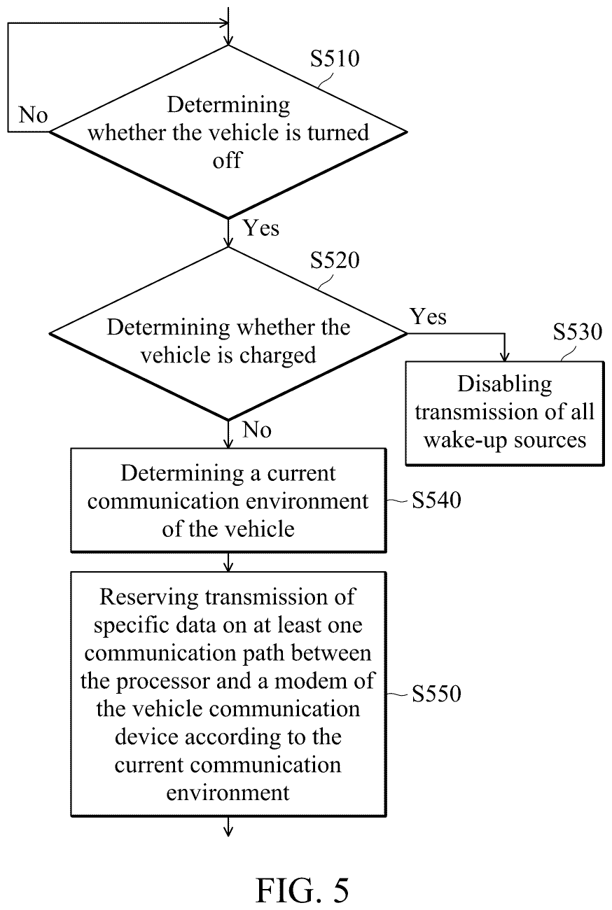

FIG. 5 is a flow chart illustrating a power-saving method according to an embodiment of the invention. The power-saving method may be applied to the vehicle communication device 120 configured in a vehicle. As shown in FIG. 5, in step S510, the processor (or application processor) of the vehicle communication device 120 may determine whether the vehicle is turned off.

When the vehicle is turned off, step S520 is performed. In step S520, the processor of the vehicle communication device 120 may determine whether the vehicle is being charged.

When the vehicle is not charged, step S530 is performed. In step S530, the processor of the vehicle communication device 120 may disable the transmission of all wake-up sources. The wake-up sources may be configured to wake up the processor of the vehicle communication device 120 which is in the sleep mode.

When the vehicle is being charged, step S540 is performed. In step S540, the processor of the vehicle communication device 120 may determine the current communication environment of the vehicle.

In step S550, the processor of the vehicle communication device 120 may reserve the transmission of specific data on at least one communication path between the processor and a modem of the vehicle communication device according to the current communication environment. The communication path comprises a control path and a data path.

In step S560, the processor of the vehicle communication device 120 may enter a sleep mode.

According to an embodiment of the invention, in the power-saving method, in step S550, when the current communication environment being a 2G or 3G network, the processor of the vehicle communication device 120 may reserve the SMS and emergency call service on the control path, and deactivate the transmission of all PDN on the control path and the data path.

According to an embodiment of the invention, in the power-saving method, in step S550, when the current communication environment being a 4G or 5G network, the processor of the vehicle communication device 120 may reserve the SMS, emergency call service and unsolicited network interface control indication on the control path, reserve the transmission of an IMS PDN on the control path, and deactivate the transmission of other PDNs on the control path. In addition, when the current communication environment being a 4G or 5G network, the processor of the vehicle communication device 120 may only reserve the transmission of the TCP/IP packets associated with ICMPv6 on the data path according to a setting. The TCP/IP packets may comprise RSRA packet

According to an embodiment of the invention, in the power-saving method, the processor of the vehicle communication device 120 may avoid camping on a 5G cell with a weak 5G signal based on a threshold.

According to an embodiment of the invention, in the power-saving method, the processor of the vehicle communication device 120 may obtain the state information of the vehicle through a CAN bus from a vehicle host device of the vehicle

In the power consumption method provided in the embodiments of the invention, more wake-sources for waking up the processor of the vehicle communication device (e.g., TBox) will be deactivated or disabled. Therefore, the power consumption of the dedicated battery for the vehicle communication device will be reduced when the vehicle is turned off.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A power-saving method, applied in a vehicle communication device in a vehicle, comprising:
determining, by a processor the vehicle communication device, whether the vehicle is turned off;
determining, by the processor, a current communication environment of the vehicle in response to the vehicle being turned off and not being charged;
reserving, by the processor, transmission of specific data on at least one communication path between the processor and a modem of the vehicle communication device according to the current communication environment, wherein the at least one communication path comprises a control path and a data path; and
entering, by the processor, a sleep mode.

2. The power-saving method of claim 1, further comprising:
disabling, by the processor, transmission of all wake-up sources in response to the vehicle being turned off and being charged, wherein the wake-up sources are configured to wake up the processor which is in the sleep mode.

3. The power-saving method of claim 1, wherein in response to the current communication environment being a 2G or 3G network, the reserving the transmission of the transmission of the specific data comprises:
reserving Short Message Service (SMS) and emergency call service on the control path; and
deactivating transmission of all packet data network (PDN) on the control path and the data path.

4. The power-saving method of claim 1, wherein in response to the current communication environment being a 4G or 5G network, the reserving the transmission of the specific data comprises:
reserving Short Message Service (SMS), emergency call service and unsolicited network interface control indication on the control path;
reserving transmission of an Internet Protocol (IP) multimedia subsystem (IMS) PDN on the control path; and
deactivating transmission of other PDNs on the control path.

5. The power-saving method of claim 4, further comprising:
only reserving transmission of control protocol/IP (TCP/IP) packets associated with Internet Control Message Protocol version 6 (ICMPv6) on the data path according to a setting.

6. The power-saving method of claim 5, wherein the TCP/IP packets comprise a router solicitation router advertisement (RSRA) packet.

7. The power-saving method of claim 4, further comprising:
avoiding camping on a 5G cell with a weak 5G signal based on a threshold.

8. The power-saving method of claim 1, further comprising:
obtaining, by the processor, state information of the vehicle through a control area network (CAN) bus from a vehicle host device of the vehicle.

9. A vehicle communication device, comprising:
a modem; and
a processor, coupled to the modem, and configured to:
determine whether the vehicle is turned off,
determine a current communication environment of the vehicle in response to the vehicle being turned off and not being charged;
reserve transmission of specific data on at least one communication path between the processor and a modem of the vehicle communication device according to the current communication environment, wherein the at least one communication path comprises a control path and a data path; and
enter a sleep mode.

10. The vehicle communication device of claim 9, wherein the processor further disables transmission of all wake-up sources in response to the vehicle being turned off and being charged, wherein the wake-up sources are configured to wake up the processor which is in the sleep mode.

11. The vehicle communication device of claim 9, wherein in response to the current communication environment being a 2G or 3G network, the processor reserves Short Message Service (SMS) and emergency call service on the control path, and deactivates transmission of all packet data network (PDN) on the control path and the data path.

12. The vehicle communication device of claim 9, wherein in response to the current communication environment being a 4G or 5G network, the processor reserves Short Message Service (SMS), emergency call service and unsolicited network interface control indication on the control path, reserves transmission of an Internet Protocol (IP) multimedia subsystem (IMS) PDN on the control path, and deactivates transmission of other PDNs on the control path.

13. The vehicle communication device of claim 12, wherein the processor further only reserves transmission of control protocol/IP (TCP/IP) packets associated with Internet Control Message Protocol version 6 (ICMPv6) on the data path according to a setting.

14. The vehicle communication device of claim 13, wherein the TCP/IP packets comprise a router solicitation router advertisement (RSRA) packet.

15. The vehicle communication device of claim 12, wherein the processor further avoids camping on a 5G cell with a weak 5G signal based on a threshold.

16. The vehicle communication device of claim 9, wherein the processor obtains state information of the vehicle through a control area network (CAN) bus from a vehicle host device of the vehicle.
